(19) United States
(12) Patent Application Publication
(10) Pub. No.: US 2021/0397310 A1
(43) Pub. Date: Dec. 23, 2021

(54) GROUPING APPLICATION WINDOWS IN USER INTERFACES

(71) Applicant: Hewlett-Packard Development Company, L.P., Spring, TX (US)

(72) Inventors: Irwan Halim, Spring, TX (US); Josue Villarreal, Spring, TX (US)

(73) Assignee: Hewlett-Packard Development Company, L.P., Spring, TX (US)

(21) Appl. No.: 15/734,697

(22) PCT Filed: Mar. 7, 2019
(86) PCT No.: PCT/US2019/021161

§ 371 Date: Dec. 3, 2020

(51) Int. Cl. G06F 3/0484; G06F 3/0481; G06F 9/451

(52) U.S. Cl. CPC G06F 3/0484; G06F 9/451; G06F 3/0481

(57) ABSTRACT

In an example implementation according to aspects of the present disclosure, a method may include assigning a selection of attributes to evaluate application windows viewable from a computing device, grouping the application windows within a user interface (UI) according to the selection of attributes, and performing an action on the computing device once a number of application windows in a group of application windows reaches a threshold value.

### BACKGROUND

An element of the user interface (UI) of an operating system (OS), such the taskbar, shows which applications may be currently running. The design and layout of the taskbar may vary between operating systems, but generally assumes the form of a strip located along one edge of the screen. The strip may include various icons which correspond to the windows open within the running applications. Clicking these icons may allow the user to easily switch between applications or windows of an application.

### BRIEF DESCRIPTION OF THE DRAWINGS

FIG. 1 illustrates a computing device for grouping application windows of applications currently running on the computing device, according to an example;

FIG. 2 illustrates a method for grouping application windows of applications currently running on the computing device, according to an example; and

FIG. 3 is a flow diagram in accordance with an example of the present disclosure.

### DETAILED DESCRIPTION

Examples disclosed herein provide the ability for grouping application windows based on their properties or attributes. Rather than limiting how application windows are grouped within the taskbar, for example, based solely on which applications are running, applications windows may be grouped according to the preferred needs of a user. As a result, each user may have a customized selection of attributes to consider how application windows will be grouped for them, as will be further described. In addition to customizing how application windows are grouped for a user, a user may be able to define various actions to be performed, for example, once a number of application windows in a group of application windows reaches a threshold value, which can increase productivity for the user by the automation of certain tasks.

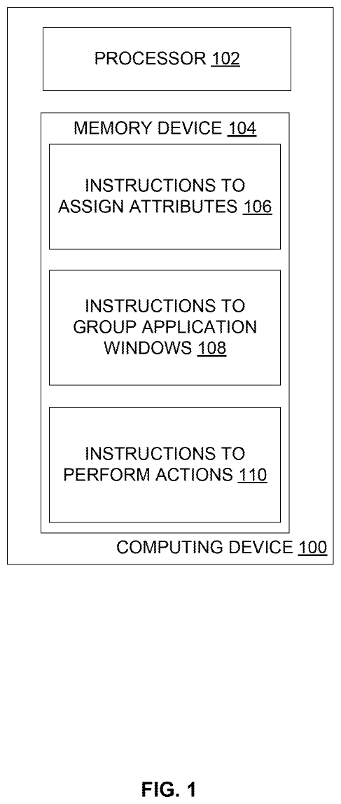

With reference to the figures, FIG. 1 illustrates a computing device 100 for grouping application windows of applications currently running on the computing device 100, according to an example. As will be further described, the application windows may be grouped within an element of a UI of an OS running on the computing device 100, such as the taskbar, based on a selection of attributes selected by a user. In addition, actions may be performed on the computing device 100 once a number of application windows in a group of application windows reaches a threshold value, thereby providing the opportunity to increase productivity by automating certain tasks.

The computing device 100 depicts a processor 102 and a memory device 104 and, as an example of the computing device 100 performing its operations, the memory device 104 may include instructions 106-110 that are executable by the processor 102. Thus, memory device 104 can be said to store program instructions that, when executed by processor 102, implement the components of the computing device 100. The executable program instructions stored in the memory device 104 include, as an example, instructions to assign attributes (106), instructions to group application windows (108), and instructions to perform actions (110).

Instructions to assign attributes (106) represent program instructions that when executed by the processor 102 cause the computing device 100 to assign a selection of attributes to evaluate application windows viewable from the computing device 100. The assignment of attributes may be initiated by a user of the computing device 100, so each user may configure their own selection of attributes to consider how the windows of applications currently running on the computing device 100 may be grouped. By default, for example, if the user makes no selection of attributes to consider, the attribute assigned to evaluate the windows of applications currently running on the computing device 100 may be limited to the different applications that are currently running, or the Application User Model IDs (AppUserModellDs) of each application currently running.

However, a number of other attributes may be selected by the user, for example, if the user desires for the windows of applications currently running on the computing device 100 to be grouped according to their preference. Examples of other attributes that may be selected by the user include but are not limited to process ID, process name, parent window, icon, window class, window description, and window titles. The user may select one attribute or a combination of attributes, according to their preference. As an example, the user may select the window description attribute in order for the computing device 100 to group application windows by its description (e.g., all windows that have the same description or start with the same description). As another example, the user may select the attributes process ID and window description in order for the computing device 100 to group all application windows produced by a single process and with the same description.

Instructions to group application windows (108) represent program instructions that when executed by the processor 102 cause the computing device 100 to group windows of applications currently running on the computing device 100 within a UI according to the selection of attributes assigned above. As an example, the windows of applications currently running on the computing device 100 may include local applications, remote applications, and virtualized applications. As an example, the application windows may be grouped within an element of the UI of the OS running on the computing device 100, such as the taskbar. In order to group the windows of applications currently running on the computing device 100, the computing device 100 may first capture exposed OS properties or attributes associated with these application windows. For example, the computing device 100 may identify the process ID, process name, parent window, icon, window class, window description, and AppUserModellD of each application window currently running on the computing device 100.

Upon identifying the attributes associated with each application window, the computing device 100 may evaluate them in order to group the windows of applications currently running on the computing device 100 according to the assignment of attributes initiated by the user, as described above. However, if the user makes no selection of attributes to consider, the computing device 100 may group the application windows according to the AppUserModelIDs of each application currently running. As a result, if multiple windows of an application are currently running on the computing device 100, the multiple windows may be grouped together. As an example, this may include grouping application windows of an application that is running both locally on the computing device 100 and running, for example, on a Citrix session.

As an example, if the user selects the window description attribute for grouping application windows currently running on the computing device 100, the computing device 100 may identify the window description of each application window currently running, then group the application windows that have the same description and/or start with the same description. For example, if the user is working on different projects on the computing device 100 (e.g., Project 1 and Project 2), the computing device 100 may identify the window description of each application window currently running on the computing device 100, as the user may include “Project 1” or “Project 2” in the name of each application window currently running.

Upon identification, the computing device 100 may then group the application windows by projects. As a result, if windows from various applications are related to a particular project (Project 1 or Project 2), they may be grouped by project, rather than by applications. This may improve user productivity, as the user may be able to easily access all application windows related to a particular project, rather than having them spread between different icons on the taskbar. Although two groups are described (Project 1 and Project 2), the number of groups generated according to the selection of attributes may vary. As described above, the user may select one attribute or a combination of attributes, in order to group the application windows currently running on the computing device 100 according to their preference.

Instructions to perform actions (110) represent program instructions that when executed by the processor 102 cause the computing device 100 to perform an action, once a number of application windows in a group of application windows reaches a threshold value. As an example, each group generated may have their own threshold value that needs to be reached, and the associated action may vary by group as well. In addition, the action performed, for example, for each group, may vary as well, based on whether the number of application windows in the group increments to the threshold value, decrements to the threshold value, or reaches the threshold value. As a result, each group may have multiple triggers to perform a number of different actions.

As an example of a group having multiple triggers, if the threshold value is five, if the number of application windows in the group increments to five (first trigger), the user may receive a notification that the older application window will be closed if another application window associated with the group is opened, for example, to conserve resources. Thereafter, if a sixth application window associated with the group is opened, thereby exceeding the threshold value of five (second trigger), the oldest application window may be closed, per the notification the user previously received. Upon decrementing back to five application windows (third trigger), the user may receive the above-mentioned notification again.

As an example, the threshold value may relate multiple threshold values, such as a lower limit of application windows or an upper limit of application windows within a group. For example, if the number of application windows in the group of application windows falls below a first threshold value, the computing device 100 may perform a first action, and if the number of application windows in the group of application windows exceeds a second threshold value greater than the first threshold value, the computing device 100 may perform a second action. Although two threshold values are described (upper and lower limit), the number of threshold values associated with a group may vary, along with varying actions to be performed for each threshold value.

Examples of actions the computing device 100 may perform include but are not limited to disconnecting a remote session (RDP, VMWare, Citrix, etc.), system reboot, system logoff, system shutdown, and launching of another application or script. For example, if the number of application windows in a group of application windows falls below a lower limit, the computing device 100 logoff the user, for example, for security purposes. The actions performed by the computing device 100, and the threshold values (upper & lower limits), may all be configurable by the user, providing for a customizable experience.

Memory device 104 represents generally any number of memory components capable of storing instructions that can be executed by processor 102. Memory device 104 is non-transitory in the sense that it does not encompass a transitory signal but instead is made up of at least one memory component configured to store the relevant instructions. As a result, the memory device 104 may be a non-transitory computer-readable storage medium. Memory device 104 may be implemented in a single device or distributed across devices. Likewise, processor 102 represents any number of processors capable of executing instructions stored by memory device 104. Processor 102 may be integrated in a single device or distributed across devices. Further, memory device 104 may be fully or partially integrated in the same device as processor 102, or it may be separate but accessible to that device and processor 102.

In one example, the program instructions 106-110 can be part of an installation package that when installed can be executed by processor 102 to implement the components of the computing device 100. In this case, memory device 104 may be a portable medium such as a CD, DVD, or flash drive or a memory maintained by a server from which the installation package can be downloaded and installed. In another example, the program instructions may be part of an application or applications already installed. Here, memory device 104 can include integrated memory such as a hard drive, solid state drive, or the like.

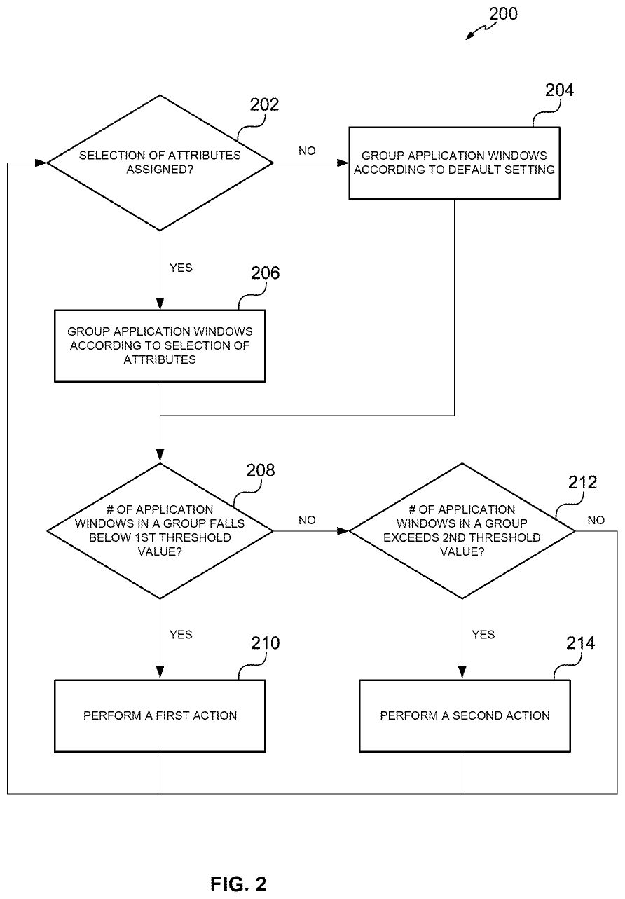

FIG. 2 illustrates a method 200, for example, at a computing device, for grouping application windows of applications currently running on the computing device, according to an example. In discussing FIG. 2, reference may be made to the example computing device 100 illustrated in FIG. 1. Such reference is made to provide contextual examples and not to limit the manner in which method 200 depicted by FIG. 2 may be implemented.

Method 200 begins at 202, where the computing device determines whether a selection of attributes has been assigned. As an example, the assignment of attributes may be initiated by a user of the computing device, so each user may configure their own selection of attributes to consider how the windows of applications currently running on the computing device may be grouped. At 204, if no selection of attributes is assigned by the user, the computing device groups windows of applications currently running on the computing device according to a default setting. As an example, the attribute assigned to evaluate the windows of applications currently running on the computing device may be limited to the different applications that are currently running, or the AppUserModellDs each application currently running.

At 206, if a selection of attributes has been assigned, for example, by the user, the computing device may group windows of applications currently running on the computing device according to the selection of attributes. As an example, the user may select one attribute or a combination of attributes, according to their preference. As an example, the application windows may be grouped within an element of the UI of the OS running on the computing device, such as the taskbar. In order to group the windows of applications currently running on the computing device, the computing device may first capture exposed OS properties or attributes associated with these application windows. For example, the computing device may identify the process ID, process name, parent window, icon, window class, window description, and AppUserModelID of each application window currently running on the computing device. Upon identifying the attributes associated with each application window, the computing device may evaluate them in order to group the windows of applications currently running on the computing device according to the assignment of attributes initiated by the user.

At 208, upon grouping the application windows as described above (e.g., according to default setting or assignment of attributes initiated by the user), while the user is utilizing the computing device, a determination is made whether the number of application windows in a group of application windows falls below a first threshold value. If so, the computing device may perform a first action at 210. Otherwise, at 212, a determination is made whether the number of application windows in a group of application windows exceeds a second threshold value. If so, the computing device may perform a second action at 214. Examples of actions the computing device may perform include but are not limited to disconnecting a remote session (RDP, VMWare, Citrix, etc.), system reboot, system logoff, system shutdown, and launching of another application or script. The actions performed by the computing device, and the threshold values (upper & lower limits), may all be configurable by the user, providing for a customizable experience. Upon performing the first or second action, or if the number of application windows in a group of application windows does not exceed the second threshold value (at 212), method 200 returns to 202, for example, to determine whether the user has made a change in the selection of attributes, or whether the attributes associated with the running applications have changed.

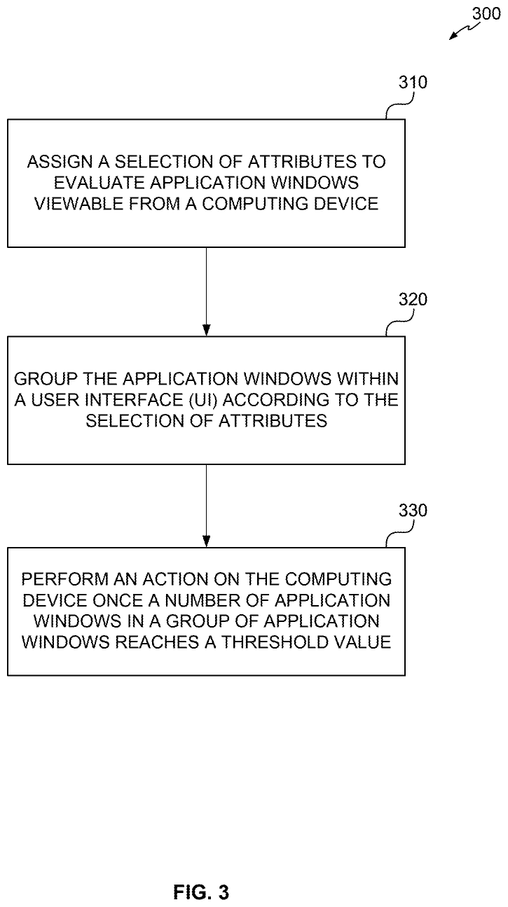

FIG. 3 is a flow diagram 300 of steps taken by a computing device to implement a method for grouping application windows of applications currently running on the computing device, according to an example. Although the flow diagram of FIG. 3 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

At 310, the computing device assigns a selection of attributes to evaluate application windows viewable from the computing device. As an example, the assignment of attributes may be initiated by a user of the computing device, so each user may configure their own selection of attributes to consider how the windows of applications currently running on the computing device may be grouped. As an example, if no selection of attributes is assigned by the user, the computing device may assign a default selection of attributes. As an example, the attribute assigned to evaluate the windows of applications currently running on the computing device may be limited to the different applications that are currently running, or the AppUserModelIDs each application currently running. However, if a selection of attributes is assigned by the user, the computing device may assign the selection of attributes made by the user. Example attributes include, but are not limited to, the process ID, process name, parent window, icon, window class, window description, and AppUserModelID.

At 320, the computing device groups the application windows within a UI according to the selection of attributes. As an example, grouping the application windows generally include grouping a first subset of the application windows into a first group and grouping a second subset of the application windows, separate from the first subset, into a second group, and so on. As attributes associated with an application window may change, the computing device may transfer an application window from the first group to the second group upon attributes associated with the application window changing. As a result, the attributes associated with the application window may no longer meet each attribute associated with the first group, but meet each attribute associated with the second group.

At 330, the computing device performs an action once a number of application windows in a group of application windows reaches a threshold value. Referring to the example described above, performing the action generally includes performing the action when the number of application windows in either the first group or the second group reaches the threshold value. As described above, each group generated may have their own threshold value that needs to be reached, and the associated action may vary by group as well. In addition, the action performed, for example, for each group, may vary as well, based on whether the number of application windows in the group increments to the threshold value, decrements to the threshold value, or reaches the threshold value. In addition, the threshold value may relate to multiple threshold values, as described above.

As an example, the threshold value may relate to a lower limit of application windows or an upper limit of application windows within a group. For example, if the number of application windows in the group of application windows falls below a first threshold value, the computing device may perform a first action, and if the number of application windows in the group of application windows exceeds a second threshold value greater than the first threshold value, the computing device may perform a second action. Examples of actions the computing device may perform are configurable and include but are not limited to disconnecting a remote session (RDP, VMWare, Citrix, etc.), system reboot, system logoff, system shutdown, and launching of another application or script.

It should be understood that examples described herein below may include various components and features. It should also be understood that, in the following description, numerous specific details are set forth to provide a thorough understanding of the examples. However, it should be understood that the examples may be practiced without limitations to these specific details. In some instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It should be understood that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method comprising:
assigning a selection of attributes to evaluate application windows viewable from a computing device;
grouping the application windows within a user interface (UI) according to the selection of attributes; and
performing an action on the computing device once a number of application windows in a group of application windows reaches a threshold value.

2. The method of claim 1, wherein the selection of attributes is configurable.

3. The method of claim 1, wherein grouping the application windows comprises grouping a first subset of the application windows into a first group and grouping a second subset of the application windows, separate from the first subset, into a second group.

4. The method of claim 3, comprising transferring an application window from the first group to the second group upon attributes associated with the application window changing.

5. The method of claim 4, wherein, upon the attributes associated with the application window changing, the attributes associated with the application window no longer meet each attribute associated with the first group, but meet each attribute associated with the second group.

6. The method of claim 3, wherein performing the action comprises performing the action when the number of application windows in either the first group or the second group reaches the threshold value.

7. The method of claim 1, wherein performing the action comprises:
performing a first action once the number of application windows in the group of application windows falls below a first threshold value; and
performing a second action once the number of application windows in the group of application windows exceed a second threshold value greater than the first threshold value.

8. The method of claim 1, wherein if an application window from the application windows meets each attribute from the selection attributes, grouping the application windows comprises grouping the application window from the application windows into the group of application windows.

9. The method of claim 1, wherein the action performed is configurable.

10. A non-transitory computer-readable storage medium comprising program instructions which, when executed by a processor, cause the processor to:
assign a selection of attributes to evaluate application windows viewable from a computing device;
group the application windows within a user interface (UI) according to the selection of attributes;
if a number of application windows in a group of application windows falls below a first threshold value, perform a first action on the computing device; and
if the number of application windows in the group of application of windows exceeds a second threshold value greater than the first threshold value, perform a second action on the computing device.

11. The non-transitory computer-readable storage medium of claim 10, wherein the selection of attributes is configurable.

12. The non-transitory computer-readable storage medium of claim 10, wherein the instructions to cause the processor to group the application windows comprises instructions to cause the processor to group a first subset of the application windows into a first group and group a second subset of the application windows, separate from the first subset, into a second group.

13. The non-transitory computer-readable storage medium of claim 12, comprising instructions to cause the processor to transfer an application window from the first group to the second group upon attributes associated with the application window changing.

14. The non-transitory computer-readable storage medium of claim 10, wherein if an application window from the application windows meets each attribute from the selection attributes, the instructions to cause the processor to group the application windows comprises instructions to cause the processor to group the application window from the application windows into the group of application windows.

15. The non-transitory computer-readable storage medium of claim 10, wherein the action performed is configurable.
